(19) United States
(12) Patent Application Publication
(10) Pub. No.: US 2014/0164753 A1
(43) Pub. Date: Jun. 12, 2014

(54) SYSTEM ON CHIP FOR PERFORMING SECURE BOOT, IMAGE FORMING APPARATUS USING THE SAME, AND METHOD THEREOF

(71) Applicant: SAMSUNG ELECTRONICS CO., LTD, Suwon-si (KR)

(72) Inventor: Jong-seung LEE, Suwon-si (KR)

(73) Assignee: Samsung Electronics Co., Ltd, Suwon-si (KR)

(21) Appl. No.: 13/848,864

(22) Filed: Mar. 22, 2013

Related U.S. Application Data
(60) Provisional application No. 61/734,158, filed on Dec. 6, 2012.

(30) Foreign Application Priority Data
Mar. 19, 2013 (KR) 10-2013-0029218

(51) Int. Cl. G06F 21/57

(52) U.S. Cl. CPC G06F 21/575
USPC 713/2

(57) ABSTRACT

A system on chip is provided. The system on chip includes: a first memory in which a plurality of encryption keys are stored, a second memory, a third memory in which an encryption key setting value is stored, and a CPU which decrypts encrypted data which is stored in an external non-volatile memory using an encryption key corresponding to the encryption key setting value from among the plurality of encryption keys, stores the decrypted data in the second memory, and performs boot using data stored in the second memory. Accordingly, security of boot can be improved.

### CROSS-REFERENCE TO RELATED APPLICATIONS

This application claims the benefit under 35 U.S.C. §119 from U.S. Provisional Application No. 61/734, 158, filed on Dec. 6, 2012, in the United States Patent and Trademark Office, and Korean Patent Application No. 10-2013-0029218, filed on Mar. 19, 2013, in the Korean Intellectual Property Office, the disclosure of which is incorporated herein by reference in its entirety.

### BACKGROUND OF THE INVENTION

1. Field of the Invention

Methods and apparatuses consistent with exemplary embodiments relate to a system on chip, an image forming apparatus using the same, and a method thereof, and more particularly, to a system on chip which performs secure boot using encrypted data, an image forming apparatus using the same, and a method thereof.

2. Description of the Related Art

With the development of electronic technologies, various kinds of electronic products have been developed. In particular, as computers come into wide use, computer peripherals are increasingly being used. The computer peripheral refers to an apparatus that improves utilization of a computer. Printers, scanners, copiers, and multi-function peripherals are the representative examples of such computer peripherals.

An image forming apparatus refers to an apparatus that performs an image forming job, that is, forms an image on paper or other media. In order to perform the image forming job, developer such as ink or toner may be used. The image forming apparatus that uses a laser method using toner may include a charging unit, a developing unit, a transfer unit, a laser scanning unit, and a fusing unit. Such units which are consumed as the job is performed, including the above units, may be referred to as consumable units. If the consumable unit is used for a predetermined time, its characteristic may be changed and thus good printing quality is not expected. In particular, a toner cartridge which contains toner should be replaced with new one when the toner is exhausted. Therefore, product manufacturers sell consumable units separately from complete products in case such a situation arises.

In recent years, the consumable unit may have a memory embedded therein to exactly determine when the consumable unit should be replaced. A variety of information on use of the consumable unit may be stored in the memory. However, there is a problem that it is easy for an unauthorized person to access the memory embedded in the consumable unit. Accordingly, information stored in the memory may be changed and thus it may be difficult to use and manage the consumable unit. Therefore, there has been an attempt to reinforce security of the memory of the consumable unit.

However, the unauthorized person may hack into the apparatus communicating with the consumable unit rather than the memory. In particular, an expedient to hack security technology applied to the consumable unit by changing a boot process of a main memory embedded in a body of the apparatus may be developed. Accordingly, there is a demand for a method for improving security of a boot process.

### SUMMARY OF THE INVENTION

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a system on chip which performs secure boot using a non-volatile memory in which encrypted data is stored, an image forming apparatus having the same, and a method thereof.

According to an aspect of an exemplary embodiment, there is provided a system on chip including: a first memory in which a plurality of encryption keys are stored; a second memory; a third memory in which an encryption key setting value is stored; and a CPU which decrypts encrypted data which is stored in an external non-volatile memory using an encryption key corresponding to the encryption key setting value from among the plurality of encryption keys, stores the decrypted data in the second memory, and performs boot using data stored in the second memory.

Initialization data may be stored in the first memory separately from the plurality of encryption keys, and the CPU may perform initialization using the initialization data and then may decrypt the encrypted data.

The system on chip may further include a first circuit which restricts access to CPU through an external port for a predetermined time.

When power is switched on, the first circuit may output a disable signal to disable the access to CPU to the CPU, and, when system preparation is completed, the first circuit may output an enable signal to enable the access to CPU to the CPU.

The first circuit may include a first register, and, when the system preparation is completed, the CPU may change a storage value of the first register.

The system on chip may further include a second circuit and a third circuit to control access to the first memory.

The second circuit may include a second register, and the third circuit may include a third register. When the system preparation is completed, the CPU may store a control value to disable access to the first memory in the second register, and may store a control value to change the access to the first memory to access to the second memory in the third register.

The CPU may execute an infinite loop when the decryption fails.

When power is switched on, the CPU may identify a memory that is designated by a setting value stored in the third memory or an external pin, and, when the first memory is designated, the CPU may perform secure boot using the encrypted data, and, when the second memory is designated, the CPU may perform normal boot using non-encrypted data which is stored in the non volatile memory.

The first memory may be a mask ROM or an OTP ROM, and the second memory may be an SRAM. The third memory may be an EFUSE memory.

According to an aspect of another exemplary embodiment, there is provided an image forming apparatus including: a consumable unit in which a CRUM chip is mounted; and a controller which performs an image forming job using the consumable unit and updates data recorded on the CRUM chip according to the image forming job. The controller may include: a non-volatile memory on which encrypted data is recorded; and a system on chip which performs secure boot using the encrypted data when the image forming apparatus is turned on, and controls the image forming apparatus according to a user command when the secure boot is completed.

The system on chip may include: a first memory in which a plurality of encryption keys are stored; a second memory; a third memory in which an encryption key setting value is stored; and a CPU which decrypts data which is stored in the non-volatile memory using an encryption key corresponding to the encryption key setting value from among the plurality of encryption keys, stores the decrypted data in the second memory, and performs boot using data stored in the second memory.

Initialization data may be stored in the first memory separately from the plurality of encryption keys, and the CPU may perform initialization using the initialization data and then may decrypt the encrypted data.

When a boot event is happened, the system on chip may restrict access to CPU through an external port for a predetermined time.

The system on chip may further include a first circuit which, when the image forming apparatus is tuned on, outputs a disable signal to disable the access to CPU to the CPU, and, when system preparation is completed, outputs an enable signal to enable the access to CPU to the CPU.

The first circuit may include a first register, and, when the system preparation is completed, the CPU may change a storage value of the first register.

When system preparation is completed, the CPU may perform a register setting job to disable access to the first memory and change the access to the first memory to access to the second memory.

When the image forming apparatus is tuned on, the CPU may identify a memory that is designated by a setting value stored in the third memory or an external pin, and when the first memory is designated, the CPU may perform secure boot using the encrypted data, and, when the second memory is designated, the CPU may perform normal boot using non-encrypted data which is stored in the external non-volatile memory.

The first memory may be a mask ROM or an OTP ROM, and the second memory may be an SRAM. The third memory may be an EFUSE memory.

According to an aspect of still another exemplary embodiment, there is provided a method for booting of an image forming apparatus including a non-volatile memory and a system on chip, the method including: initializing using initialization data which is stored in a first memory of the system on chip; when the initializing is performed, decrypting encrypted data which is stored in the non-volatile memory using one of a plurality of encryption keys which are stored in the first memory; storing the decrypted data in a second memory of the system on chip; and performing boot using data which is stored in the second memory.

The method may further include: when the image forming apparatus is turned on, identifying a memory that is designated according to an input value input through a third memory of the system on chip or an external pin; and, when the designated memory is the first memory, disabling access to a CPU of the system on chip.

The method may further include, when system preparation is completed, enabling the access to the CPU.

The method may further include: when the system preparation is completed, disabling the access to the first memory; and performing register setting to change the access to the first memory to access to the second memory.

According to the above-described exemplary embodiments, security of a boot process can be improved and thus damage caused by malicious hacking by an unauthorized person can be prevented.

### BRIEF DESCRIPTION OF THE DRAWINGS

The above and/or other aspects will be more apparent by describing in detail exemplary embodiments, with reference to the accompanying drawings, in which:

FIG. 1 is a block diagram illustrating a system on chip according to an exemplary embodiment;

FIG. 2 is a flowchart to explain a secure boot method according to an exemplary embodiment;

FIG. 3 is a block diagram illustrating a system on chip according to another exemplary embodiment;

FIG. 4 is a block diagram illustrating a main board on which a system on chip is mounted according to still another exemplary embodiment;

FIG. 5 is a flowchart to explain a secure boot method according to another exemplary embodiment;

FIG. 6 is a flowchart to explain a secure boot method according to still another exemplary embodiment;

FIG. 7 is a circuit diagram illustrating an example of the system on chip of FIG. 4 in detail;

FIG. 8 is a view illustrating an example of a layout of a secure firmware;

FIG. 9 is a view illustrating an example of a memory map to perform secure boot;

FIG. 10 is a block diagram illustrating an example of an image forming apparatus in which a system on chip is mounted; and

FIG. 11 is a block diagram illustrating an example of a CRUM chip which is mountable in a consumable unit.

### DETAILED DESCRIPTION OF THE PREFERRED EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

It is common that an electronic apparatus performs a boot process to normally operate when it is turned on. The electronic apparatus performs appropriate initialization, and loads and executes a program through the boot process. The boot process that determines the initial state of the electronic apparatus may affect an important operating parameter of the electronic apparatus and thus may practically affect the electronic apparatus when it is used. Therefore, if the boot process is so easy to access that anyone can change it, there is a risk that a program that a user does not intend is loaded. Therefore, there is a demand for a method for safely booting so that a boot process cannot be changed arbitrarily, that is, a secure boot method. To achieve secure boot, boot data may be stored in a non-volatile memory of the electronic apparatus in an encrypted state. A system on chip 100 for controlling the operation of the electronic apparatus accesses the non-volatile memory, decrypts the encrypted data, and performs a secure boot process. Hereinafter, a system on chip and a secure boot method thereof according to various exemplary embodiments will be explained.

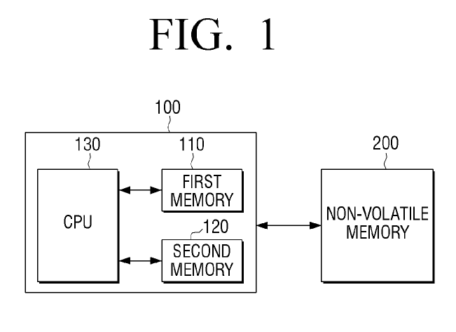

FIG. 1 is a block diagram illustrating a system on chip according to an exemplary embodiment. Referring to FIG. 1, a system on chip 100 performs secure boot using a non-volatile memory 200 in which encrypted data is stored. The system on chip 100 and the non-volatile memory 200 of FIG. 1 may be embedded in a single electronic apparatus.

The system on chip 100 performs a boot process using the encrypted data which is stored in the non-volatile memory 200. Specifically, various data such as a boot block started symbol (BSS), a kernel, an initialization program, an operating system (OS), the other OS (wireless stack), an engine, emulation, a fixed segment, a heap, an authentication key, an encrypted OS, and a device driver may be encrypted and stored in the non-volatile memory 200.

The data may be encrypted in various methods. For example, a data encryption standard (DES) method, a triple DES (TDES) method, an advanced encryption standard (AES) method, a SEED algorithm, a Rivest Shamir Adleman (RSA) method, and an academy-research institute-agency (ARIA) algorithm may be used.

The DES method refers to a method that encrypts and decrypts data using a symmetric key encryption algorithm using a key of 56 bits. The TDES method refers to a method that repeats the DES three times. The AES method refers to a method that encrypts decrypts a block of a size of 128 bits using a key of any multiple of 32 bits such as 128, 160, 192, 224, or 256 bits. The SEED method, which is similar to the AES method, refers to a 128-bit block encryption method that encrypts and decrypts data using an encryption key of 128 bits or 256 bits. The RSA method is a kind of public key encryption system that uses a one-way function, and the ARIA algorithm is a block encryption method that encrypts and decrypts a block of 128 bits using a key of 128, 192, or 256 bits.

Various data that are encrypted in various encryption methods described above may be stored in the non-volatile memory 200. The stored data or the encryption method may be selectively applied according to a characteristic of a product in which the system on chip 100 and the non-volatile memory 200 of FIG. 1 are mounted, or other environmental conditions.

Referring to FIG. 1, the system on chip 100 includes a first memory 110, a second memory 120, and a central processing unit (CPU) 130. An encryption key may be stored in the first memory 110. The first memory 110 may be implemented by using a mask read only memory (ROM) or a one time programmable (OTP) memory.

The mask ROM is a memory that memorizes data in advance at the manufacturing time and does not allow the user to modify the data. The OTP memory may be used in in-system programming, but is a kind of programmable ROM that does not allow data to be modified once it is programmed.

The encryption key is a key for decrypting the data which is stored in the non-volatile memory 200, in particular, a boot code. The non-volatile memory 200 may store data that is encrypted in one of the above-described methods, and an encryption key corresponding to the encrypted data may be stored in the first memory 110.

Also, the first memory 110 may store information on a boot loader. The boot loader refers to a program that is executed in advance before an OS starts, finishes all operations necessary for starting a kernel, and finally starts the OS. That is, the OS is divided into a kernel in which real commands are driven, a framework which transmits commands included in a program to the kernel, and a user interface (UI) which is driven on the kernel and the framework. The boot loader refers to a program that prepares hardware prior to staring the kernel. Specifically, private boot loader information may be stored in the first memory 110. The private boot loader information may include information necessary for initializing the system.

The second memory 120 is an internal memory that is used for boot. The second memory 120 may be implemented by using an SRAM which does not require initialization. However, this should not be considered as limiting.

The CPU 130 decrypts encrypted data which is stored in the non-volatile memory 200 located outside the system on chip 100, using an encryption key stored in the first memory 110, and stores the decrypted data in the second memory 120. After that, the CPU 130 may perform boot using the data stored in the second memory 120. The decryption method may correspond to the data encryption method.

For example, if the AES method is applied, the data is encrypted by repeating an AddRoundKey process which performs XOR operation with respect to the data to be encrypted and an initially input cipher key, an SubBytes process which substitutes a result of the XOR operation according to a specific rule, a ShiftRows process which shifts a data row, and a MixColumn process which mixes the data row 10 times. The non-volatile memory 200 may store data that is encrypted in the above-described method. The CPU 130 may decrypt the encrypted data by repeating reverse processes corresponding to the above-described encryption processes. The decrypted data is stored in the second memory 120 and the CPU 130 performs a subsequent boot process using the stored data.

If the RSA method is applied, the data is encrypted and decrypted using a public key {N, E} and a private key {N, D}. Specifically, two great primer numbers ‘p’ and ‘q’ are selected and Modulus N=p*q and PI(N) are calculated. Also, E is arbitrarily selected so that E is relatively prime to PI(N)=(p−a)(q−1). D which has a relationship of E*D mod PI(N)−1 is calculated using an extended Euclidean algorithm. As a result, RSA encryption may be performed using the public key {N, E} and the private key {N, D}. The RSA encryption may be performed using equation E(M)=M̂E mod N=C. M denotes data to be encrypted. The non-volatile memory 200 may store a boot code that is encrypted according to this equation. In this case, the CPU 130 may perform RSA decryption using equation D(C)=ĈD mod N=((M̂E)̂D) mod N=M. The decrypted data is stored in the second memory 120 and the CPU 130 performs a subsequent boot process using the stored data.

According to the above-described method, the system on chip 100 loads the data stored in the external memory 200 thereinto in the encrypted state, decrypts the data and performs boot. Accordingly, even if an unauthorized person hacks data exchanged between the external memory 200 and the system on chip 100, the boot process cannot be changed and boot security can be improved.

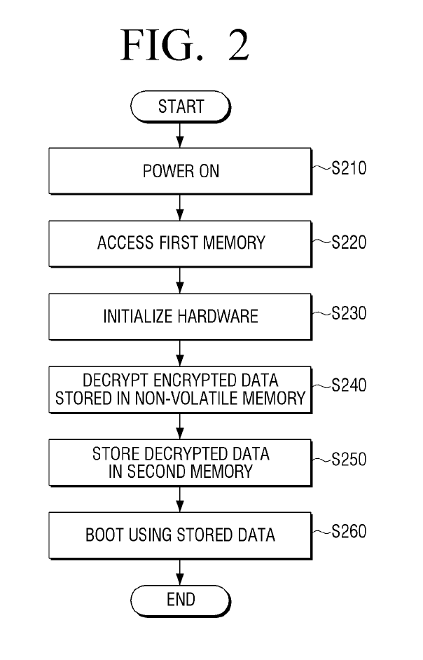

FIG. 2 is a flowchart to explain a secure boot method in detail according to an exemplary embodiment. Referring to FIG. 2, if the electronic apparatus in which the system on chip is mounted is turned on (S210), the system on chip accesses the first memory 110 and reads data stored in the first memory 110 (S220). Specifically, the CPU 130 goes to a reset vector to which a specific address is allocated and fetches an instruction. In the present exemplary embodiment, the address of the reset vector may be designated as the first memory 110.

If the first memory 110 is designated, the CPU 130 performs secure boot using the data stored in the first memory 110. The first memory 110 may store various data such as a code necessary for initializing the system and a code or an encryption key necessary for decrypting an encrypted external program code.

The CPU 130 detects the code necessary for initializing the system from the first memory 110 and performs an initializing job with respect to basic hardware (S230). The initializing job may include advancing a clock used in the system on chip 110 using an internal phase lock loop (PLL) circuit or initializing a double data rate (DDR) controller to use a DDR memory. The initializing job may further include various initializing operations such as initially driving various applications, set up to form a communication channel with internal or external apparatuses of the electronic apparatus, initializing a memory value, setting an internal register value, input/output (I/O) setting, serial setting, obtaining a MAC address, and Ethernet port setting. Also, the initializing job may include preparing another hardware mounted in the electronic apparatus along with the system on chip 100. Such initializing operations may be implemented in various ways according to a kind of the electronic apparatus in which the system on chip 100 is mounted. In addition, the code stored in the first memory 110 may be used for other operations. For example, data CPU 130 reads a boot option pin setting (SPI/NAND/SD) value, and leads data into the second memory 120 according to the corresponding boot option.

After that, the CPU 130 decrypts the encrypted data which is loaded into the system on chip 100 (S240). The CPU 130 may decrypt the data using an encryption key stored in the first memory 110. The CPU 130 stores the decrypted data in the second memory 120 or the DDR memory (S250). The CPU 130 performs boot using the decrypted data (S260).

That is, the CPU 130 may perform boot using data such as a decrypted boot block started symbol (BSS), a kernel code, an initialization program, an OS, the other OS (wireless stack), an engine, emulation, a fixed segment, and a heap. The boot refers to operations of loading a kernel, executing a framework, executing a UI, and starting an OS.

According to the exemplary embodiment described above, secure boot can be performed using the first memory and the second memory of the system on chip 100, which are not encrypted, and the encrypted data stored in the external non-volatile memory 200.

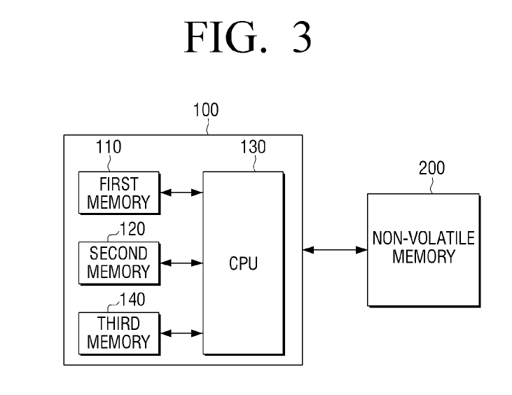

FIG. 3 is a block diagram illustrating a system on chip according to another exemplary embodiment. Referring to FIG. 3, the system on chip 100 may further include a third memory 140 in addition to the first memory 110, the second memory 120, and the CPU 130.

According to another exemplary embodiment, a plurality of encryption keys may be stored in the first memory 110. A setting value for selecting one of the plurality of encryption keys may be stored in the third memory 140. In this specification, such a setting value is referred to as an encryption key setting value. The third memory 140 may be implemented by using an electrical fuse (EFUSE) memory which is a kind of OPT memory. However, this should not be considered as limiting.

The CPU 130 determine which of the plurality of encryption keys stored in the first memory 110 will be selected according to the setting value that is, encryption key setting value, stored in the third memory 140. If a key in use is exposed, the manufacturer of the system on chip 100 or the electronic apparatus in which the system on chip 100 is mounted changes the key by changing encryption key setting value of the third memory 140.

According to the present exemplary embodiment, even if one encryption key is exposed, there is no need to replace the whole system on chip and the CPU 130 may deal with this problem simply by changing the setting value programmed in the third memory 140.

The other operations of the second memory 120 and the CPU 130 are the same as described in the above first exemplary embodiment and thus a redundant explanation is omitted.

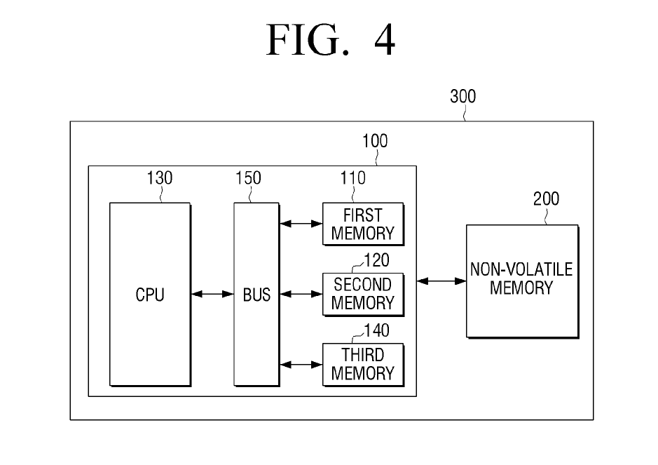

FIG. 4 is a block diagram illustrating a main board 300 on which the system on chip 100 and the non-volatile memory 200 are mounted. Referring to FIG. 4, the system on chip 100 and the non-volatile memory 200 may be mounted on the single main board 300. Besides the system on chip 100 and the non-volatile memory 200, various parts may be mounted on the main board 300, but are not illustrated for the convenience of explanation.

The system on chip 100 includes the first memory 110, the second memory 120, the CPU 130, the third memory 140, and a bus 150. Referring to FIG. 4, the CPU 130 may be connected to various elements including the first to third memories 110, 120, and 140 through the bus 150. The bus 150 may include various kinds of buses such as an address bus, a data bus, and a control bus.

The system on chip 100 shown in FIGS. 3 and 4 may appropriately select an encryption method using the third memory 140.

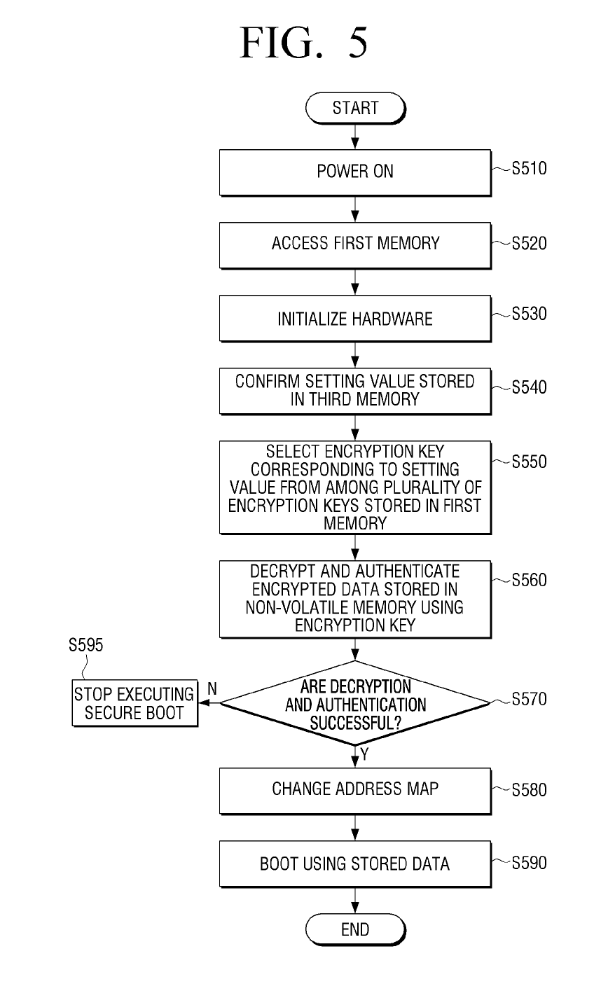

FIG. 5 is a flowchart to explain a secure boot method of the system on chip shown in FIG. 3 or 4. Referring to FIG. 5, if the electronic apparatus in which the system on chip 100 is mounted is turned on (S510), the CPU 130 of the system on chip 100 accesses the first memory 110 (S520) and identifies initialization data. The access to the first memory 110 may be performed according to an instruction that is fetched from a reset vector. The CPU 130 initializes basic hardware according to the identified initialization data (S530). An example of the initializing operation has been described above with reference to FIG. 2 and a redundant explanation is omitted. The CPU 130 may prohibit access to CPU through an external port while secure boot is performed.

If initialization is completed, the CPU 130 identifies a setting value which is stored in the third memory 140 (S540), and selects an encryption key corresponding to the setting value from among the plurality of encryption keys stored in the first memory 110 (S550). If the encryption key is selected, the CPU 130 decrypts encrypted data which is stored in the non-volatile memory 200 using the encryption key and performs authentication (S560). The decrypted data is copied into the second memory 120 or the DDR memory.

As described above, the data is decrypted according to various encryption algorithms such as a DES method, a TDES method, an AES method, a SEED algorithm, an RSA method and an ARIA method.

The authentication is a process of verifying effectiveness of an authentication code of the data. To achieve the authentication, an authentication algorithm such as HMAC-SHA256, HMAC-SHA1, and HMAC-MD5 and so on may be used. These algorithms are key-based algorithms that share a single secret key. In particular, the HMAC is defined in RFC 204 (keyed-hashing for a message authentication code). The encryption key value for decrypting and the key value for authenticating may be stored in the first memory 110 as described above.

If the authentication code is not effective or decryption fails (S570), the CPU 130 stops executing the program and falls in an infinite loop (S595).

On the other hand, if the decryption and the authentication succeed, and all system preparations are completed, the CPU 130 changes an address map (S580). Accordingly, when there is an attempt to access the first memory 110, the access is forcedly changed to access to the second memory 120.

After that, the CPU 130 performs boot using the decrypted data which is copied into the second memory 120 (S590). The boot process has been described above and thus a redundant explanation is omitted.

In the above exemplary embodiment, the system on chip which performs secure boot and the operations thereof have been described. However, according to an exemplary embodiment, secure boot or normal boot may be selectively performed according to an environment in which the system on chip is used.

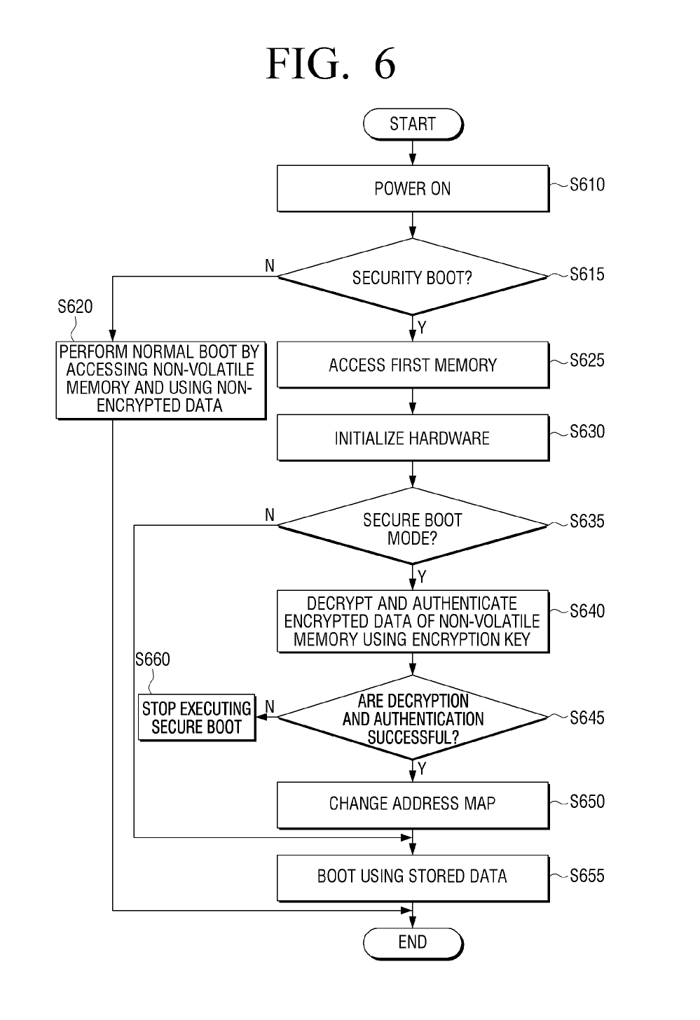

FIG. 6 is a flowchart to explain a boot method of a system on chip according to still another exemplary embodiment. According to still another exemplary embodiment, the non-volatile memory 200 may store encrypted data and non-encrypted data altogether.

In this state, if the electronic apparatus is turned on (S610), the CPU 130 determines whether to perform secure boot or normal boot (S615). That is, if power is switched on, the CPU 130 goes to a reset vector and fetches an instruction. The first memory 110 or the second memory 120 may be designated as the reset vector. That is, the first memory 110 and the second memory 120 are mapped onto the same address (for example, 0xffff0000) by means of the bus 150. If the CPU 130 identifies the address 0xffff0000 from the reset vector, the CPU 130 accesses one of the first memory 110 and the second memory 120 that is designated. The memory may be designated by a designation value which is input through an external pin connected to the CPU 130 or a designation value which is stored in the third memory 140.

If the second memory 120 is designated, it is determined that normal boot rather than secure boot is performed (S615: N). In this case, the CPU 130 accesses the non-volatile memory 200 and performs normal boot using the non-encrypted data.

On the other hand, if the first memory 110 is designated, it is determined that secure boot is performed (S615: Y). If secure boot is performed, the CPU 130 accesses the first memory 110 (S625) and detects initialization data (S630). Prior to this, the CPU 130 may prohibit the CPU 130 access through an external port.

The CPU 130 initializes basic hardware using the initialization data (S635). The CPU 130 loads encrypted data which is stored in the non-volatile memory 200 into the second memory 120.

After that, the CPU 130 determines whether a secure boot mode is set or not (S635). That is, the CPU 130 may determine whether to perform secure boot regardless of whether the first memory 110 is designated or not using the external pin (or a first external pin) or the third memory 140. For example, even if non-encrypted data is stored in the non-volatile memory 200, the CPU 130 may perform boot using the first memory 110. In this case, decryption is omitted. It is determined whether the mode is a secure boot mode or not based on another designation value stored in the third memory 140 or another external pin (hereinafter, a second external pin).

If secure boot mode is set, the CPU 130 performs decryption and authentication using an encryption key which is stored in the first memory 110 (S640). The decryption and the authentication may be performed according to the above-described various algorithms.

If at least one of the decryption and the authentication fails (S645: N), the CPU 130 falls in an infinite loop (S660). On the other hand, if the decryption and the authentication succeed (S645: Y), the CPU 130 changes the address map (S650). After that, the CPU 130 may control the second memory 120 to be used instead of the first memory 110. Accordingly, it is impossible to access the code stored in the first memory 110 after the address map is changed. At this time, it is impossible to trace a code and a key value with a JTAG and the address is set to be read 0xf11111 when being accessed.

After the address map is changed, the CPU 130 jumps to the data copied into the second memory 120 (for example, a first boot loader) and performs boot using this data (S655). The first boot loader refers to a boot loader for loading a second boot loader into the memory. The core functions of the boot loader to provide a UI and load a kernel are performed by the second boot loader. The boot loader may be divided into the first and second boot loaders considering an insufficient space.

As described above, the system on chip may be implemented in various forms and perform secure boot. The above described exemplary embodiments can be changed in combination with at least one of other exemplary embodiments. The FIGs and descriptions related to these exemplary embodiments are omitted.

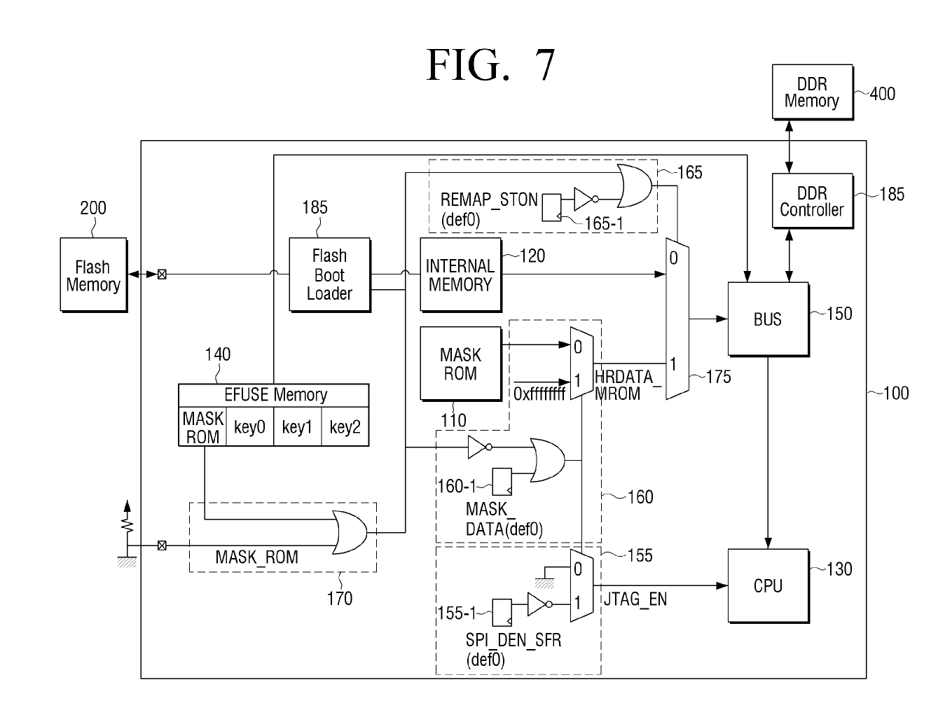

FIG. 7 is a view to explain an example of a system on chip in detail. Referring to FIG. 7, the system on chip 100 may include a DDR controller 185 and various circuits 155, 160, 165, 170, 175, and 180 in addition to the first memory 110, the second memory 120, the CPU 130, the third memory 140, and the bus 150. In FIG. 7, the first memory 110 is implemented by using a mask ROM and the second memory 120 is implemented by using an SRAM. The third memory 140 is implemented by using an EFUSE memory. The third memory 140 may store a setting value (keys 1, 2, and 3) for selecting an encryption key and a designation value (mask ROM) for setting whether to perform secure boot.

Each of the circuits 155, 160, 165, 170, 175, and 180 may be configured by a combination of various elements such as a register, a logic circuit, and a multiplexer. The first circuit 155 includes a first register 155-1. The CPU 130 may control access to CPU through an external port using the first circuit 155. Specifically, the first circuit 155 inputs a JTAG_EN signal corresponding to a value registered at the first register 155-1 to the CPU 130.

That is, if a boot event is generated, the fourth circuit 170 outputs a result of OR operation performed with respect a value which is input through an external pin and a designation value which is input through the third memory 140. The boot event includes an event in which the system on chip or the apparatus in which the system on chip is mounted is turned on. If secure boot is to be performed, 1 may be recorded on the third memory 140. Accordingly, the fourth circuit 170 outputs 1. The output value of the fourth circuit 170 is input to the second circuit 160 and the third circuit 165.

The second circuit 160 and the third circuit 165 include second and third registers 160-1 and 165-1, respectively, to control the access to the first memory 110. The output value 1 of the fourth circuit 170 to be input to the second circuit 160 is inverted. Accordingly, 0 is input to the second circuit 160. The second circuit 160 outputs a value of OR operation performed with respect to the input value 0 and a storage value of the second register 160-1 using an OR gate. Since 0 may be recorded on the second register 160-1 in an initial state, the second circuit 160 eventually outputs 0 to the first circuit 155.

The first circuit 155 includes the first register 155-1. The first circuit 155 includes a multiplexer to selectively output a value stored in the first register 155-1 or an external value. If 0 is input from the second circuit 160, the first circuit 155 outputs a signal to disable the access to CPU to the CPU 130. Accordingly, the access to CPU through an external port may be restricted for a predetermined time, that is, a time during which secure boot is performed after an apparatus with the SOC 100 is turned on.

If the apparatus is turned on, the CPU 130 identifies a memory that is designated according to a setting value stored in the third memory 140 or an input value input through an external pin. If the designated memory is the first memory 110, the CPU 130 stores a first value (for example, 1) to disable the access to CPU in the first register 155-1.

If system preparation is completed, the CPU 130 stores a second value (for example, 0) to enable the access to CPU in the first register 155-1. Also, the storage value of the second register 160-1 of the second circuit 160 may also be changed.

Specifically, if system preparation is completed, the CPU 130 records a control value (for example, 1) to disable the access to the first memory 110 on the second register 160-1, and blocks data of all regions of the first memory 110 from being read out. If the storage value of the second register 160-1 is changed to 1, the output value of the second circuit 160 is changed to 1.

Also, the CPU 130 records a control value (for example, 1) to change the access to the first memory 110 to the access to the second memory 120 on the third register 165-1. In this case, the access to the first memory 110 is automatically changed to the access to the second memory 120 when the CPU 130 accesses the first memory 110. Since a decrypted code is copied into the second memory 120 in advance, the CPU 130 may use the same.

The fourth circuit 170 may include an OR gate to provide a designation value which is input through an external pin or the third memory 140. The CPU 130 may determine whether to perform secure boot or not according to the designation value which is input through the fourth circuit 170.

A multiplexer 175 selectively inputs a value output from the second memory 120 or the second circuit 160 to the bus 150.

A flash boot loader 180 refers to a flash memory for storing a boot loader. The flash boot loader 180 loads a private boot loader stored in the non-volatile memory 200 when normal boot is performed. The CPU 130 performs normal boot using the flash boot loader 180.

The DDR controller 185 is a controller that controls data reading/writing (R/W) on an external DDR memory 400.

As described above, the system on chip 100 may be implemented in various forms and may be used along with the non-volatile memory 200 and the DDR memory 300.

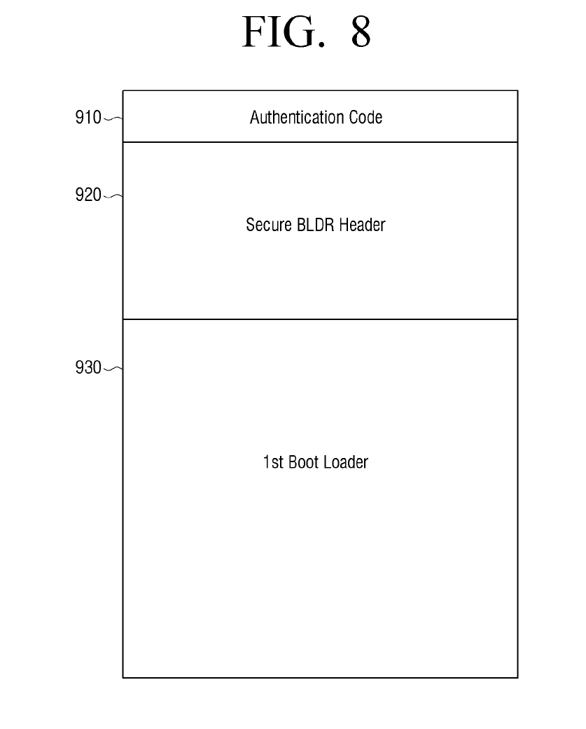

FIG. 8 is a view illustrating an example of a layout of data which is stored in the first memory 110. Referring to FIG. 8, the first memory 110 stores an authentication code 910, a secure boot loader header 920, and a first boot loader 930.

The authentication code 910 may be encrypted and stored according to various encryption algorithms. For example, the authentication code 910 may be encrypted and stored according to an authentication algorithm such as HMAC-SHA256, HMAC-SHA1, and HMAC-MD5 as described above.

The secure boot loader header 920 may include electronic signature information, an offset value, a size, weather information, and a user ID. The secure boot loader header 920 may be encrypted and stored in one of various encryption algorithms such as a DES method, a TDES method, an AES method, a SEED algorithm, an RSA method, and an ARIA algorithm.

The first boot loader 930 may be encrypted and stored in an encrypted state for the sake of internal security.

In FIG. 8, the boot loader 930 may be set to start according to a plurality of NOP instructions for the sake of internal security.

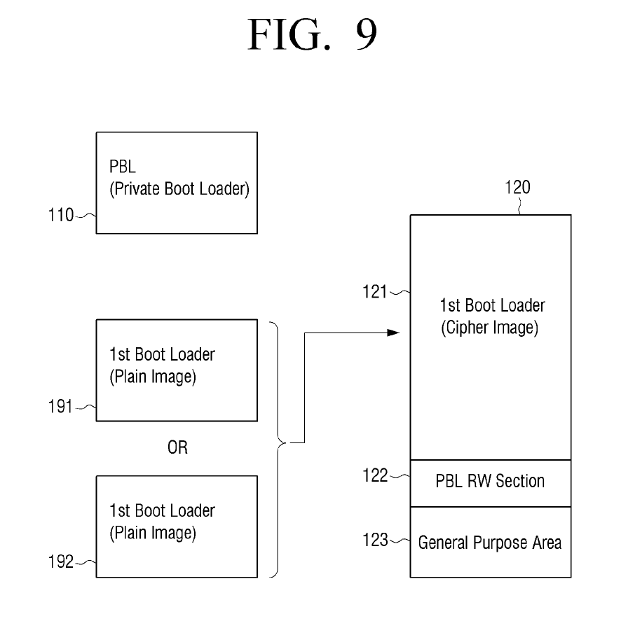

FIG. 9 is a view illustrating an example of a memory map of the system on chip 100. Referring to FIG. 9, a private boot loader is stored in a specific address of the first memory 110. The private boot loader may be used for normal boot.

On the other hand, if secure boot is performed, the CPU 130 may load the first boot loader stored in the non-volatile memory 200 into a region 191 of a stone register or a specific region 192 of the second memory 120. The CPU 130 decrypts the first boot loader using an encryption key and copies the decrypted first boot loader into a specific region 121 of the second memory 120. The second memory 120 may be provided with various regions such as an RW section 122 to read/write and a general-purpose region 123.

As described above, the system on chip may process the encrypted data of the external non-volatile memory 200 using various internal memories.

Also, the manufacturer of the electronic apparatus or a service provider who uses the electronic apparatus may wish to safely store his/her own secret key in the electronic apparatus. The secret key may be used for various purposes. For example, the secret key may be used in encrypting some or all of the regions of the kernel or creating a safe communication channel between the electronic apparatus and the manufacturer or between the electronic apparatus and the service provider. The first memory 110 or the third memory 140 of the system on chip 100 may be implemented by using an OTP memory and may store the above-described secret key.

The system on chip according to the above-described various exemplary embodiments may be used in various kinds of electronic apparatuses. For example, the system on chip may be used in an image forming apparatus such as a printer, a multifunction peripheral, a facsimile machine, or a scanner.

According to an exemplary embodiment, an image forming apparatus may include a variety of consumable units and a controller. The controller performs an image forming job using the consumable units. If a CRUM chip is mounted in the consumable unit, the controller may update data which is recorded on the CRUM chip according to the image forming job.

The controller may include a non-volatile memory and a system on chip. The non-volatile memory may record encrypted data thereon. If the image forming apparatus is turned on, the system on chip performs secure boot using the encrypted data which is stored in the non-volatile memory, and, if the secure boot is completed, controls the image forming apparatus according to a user command.

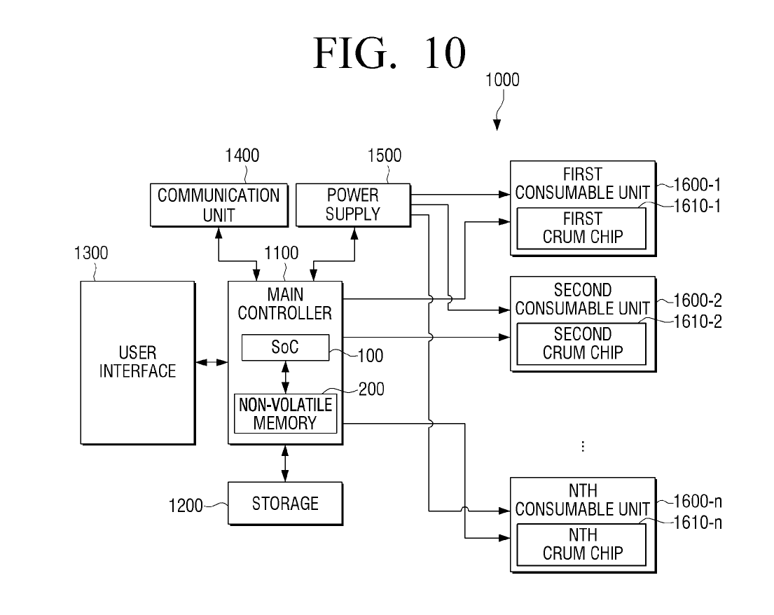

FIG. 10 is a block diagram illustrating an example of an image forming apparatus. Referring to FIG. 10, an image forming apparatus 1000 includes a controller 1100, a storage 1200, a user interface 1300, a communication unit 1400, a power supply 1500, and a plurality of consumable units 1600-1 to 1600-n.

The storage 1200 may include a hard disk drive (HDD) or other storages. The storage 1200 is not necessarily implemented by using an internal memory and may be implemented by using an external memory which is removably mounted on the image forming apparatus 1000.

The user interface 1300 is a part to receive various selection commands from the user. The user interface 1300 may include a display panel and at least one button. In this case, the display panel may be implemented by using a touch screen. The user interface 1300 may provide various UI screens, and the user may input various user commands by directly touching the UI screen or manipulating the button of the user interface 1300.

The communication unit 1400 may be connected to an external device through a network or a local area network (LAN) and may receive data and commands. That is, the communication unit 1400 may be connected to a host PC through a local interface or may be connected to a plurality of external devices in a wired or wireless manner through a network. IEEE of U.S., 802.11 standard, hyper LAN standard of Europe, or MMAC-PC standard of Japan may be used as a wireless communication standard. Besides these, various communication methods such as Wi-Fi, Bluetooth, Zigbee, or near field frequency communication (NFC) may be used for communication.

The power supply 1500 supplies power to each of the elements of the image forming apparatus 1000. Specifically, the power supply 1500 receives common AC power from an external source (AC_IN), converts it into DC power of an electric potential appropriate to each element using elements such as a transformer, an inverter, and a rectifier, and outputs the DC power (DC_OUT).

The controller 1100 includes a system on chip 100 and a non-volatile memory 200. Accordingly, if the image forming apparatus 1000 is turned on, the controller 1100 performs secure boot. The secure boot may be performed in various methods as described above. The system on chip 100 which performs secure boot and the operations thereof have been described above and thus a redundant explanation is omitted.

If boot is completed, the controller 1100 controls an overall operation of the image forming apparatus according to data and a command of an external device which is connected to the image forming apparatus through the communication unit 1400, or a user selection command which is input through the user interface 1300.

Specifically, if a print command is executed in a printer driver which is installed in a host PC or an application, the printer driver of the host PC generates print data by converting a corresponding document in a predetermined printer language. The controller 1100 receives such print data through the communication unit 1400. The controller 1100 converts the print data into a bitmap image comprised of “0” and “1” using a halftone table, and controls the plurality of consumable units 1600-1 to 1600-n to print the bitmap image on paper.

Various kinds of consumable units 1600-1 to 1600-n may be provided according to a kind of the image forming apparatus 100. If the image forming apparatus is a laser multifunction peripheral, the consumable units 1600-1 to 1600-n may be a paper feeder, a charging unit, a laser scanning unit, a developing unit, a transfer unit, a fusing unit, a paper discharge unit, a scanning unit, and a scan motor. At least some of the consumable units 1600-1 to 1600-n may include CRUM chips 1610-1 to 1610-n.

The CRUM chips 1610-1 to 1610-n may be implemented by using only memories, or may be implemented by include a memory and a CPU. The CRUM chips 1610-1 to 1610-n may have an OS separately from the controller 1100, and may perform initialization by themselves using the OS. The CRUM chips 1610-1 to 1610-n perform authentication with respect to the controller 1100, and, if authentication succeeds, performs encryption data communication. The CRUM chips 1610-1 to 1610-n may be implemented in various forms.

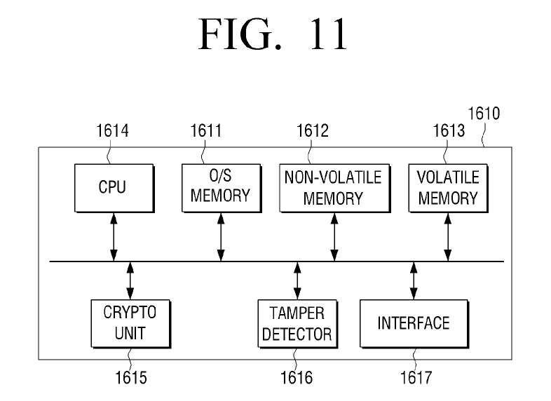

FIG. 11 is a block diagram illustrating an example of a CRUM chip in detail. Referring to FIG. 11, a CRUM chip 1610 includes an OS memory 1611, a non-volatile memory 1612, a volatile memory 1613, a CPU 1614, a crypto unit 1615, a tamper detector 1616, and an interface 1617. Although not shown, the CRUM chip 1610 may further include a clock unit to output a clock signal and a random value generator to generate a random value for authentication. However, some of the elements may be deleted and may be included in another element.

The OS memory 1611 stores an OS for driving the consumable unit 1610. The non-volatile memory 1612 may store various data and programs regarding the consumable unit and the CRUM chip. Specifically, the non-volatile memory 1612 may store electronic signature information, various encryption program codes, state information of the consumable units (for example, toner remaining information, replacement time information, a number of copies remaining to be printed), unique information (for example, manufacturer information, manufacturing date information, a serial number, a product model name), and after service information. The CPU 1614 may load the program and the data which are stored in the non-volatile memory 1612 into the volatile memory 1613, and may use them.

The crypto unit 1615 supports an encryption algorithm and may cause the CPU 1614 to perform authentication with respect to the controller 1100 provided in the image forming apparatus or to perform encrypted communication. Specifically, the crypto unit 1615 may perform authentication or encryption data communication using the above-described various encryption algorithms.

The tamper detector 1616 is to protect various physical hacking attempts, that is, protects tampering. Specifically, the tamper detector 1616 monitors an operating environment such as voltage, temperature, pressure, light, and frequency, and, if there is an attempt such as Decap, the tamper detector 1616 deletes or physically blocks the data. In this case, the tamper detector 1616 may include separate power supply.

By providing the crypto unit 1615 and the tamper detector 1616 as described above, systematic data security using both hardware and software is possible.

The interface 1617 connects the CPU 1614 and the controller 1100 each other. Specifically, the interface 1617 may be implemented by using a serial interface or a wireless interface.

As described above, the system on chip may be mounted in the image forming apparatus and may perform secure boot. Accordingly, the system on chip can prevent an unauthorized person from changing the boot process or hacking the data of the consumable unit. Also, the system on chip may be mounted and used in various electronic apparatuses besides the image forming apparatus.

The secure boot operation may be performed by a program which is stored in a non-transitory computer readable medium. The non-transitory computer readable medium refers to a medium that stores data semi-permanently rather than storing data for a very short time, such as a register, a cache, and a memory, and is readable by an apparatus. Specifically, the above-described various applications or programs may be stored in a non-transitory computer readable medium such as a compact disc (CD), a digital versatile disk (DVD), a hard disk, a Blu-ray disk, a universal serial bus (USB) memory stick, a memory card, and a read only memory (ROM), and may be provided.

Specifically, a non-transitory computer readable medium which stores a program code to perform: initializing using initialization data which is stored in a first memory of a system on chip; when the initializing is performed, decrypting encrypted data which is stored in a non-volatile memory using one of a plurality of encryption keys which are stored in the first memory; storing the decrypted data in a second memory of the system on chip; and performing boot using data which is stored in the second memory in sequence may be used.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

1. A system on chip comprising:
a first memory to store a plurality of encryption keys;
a second memory;
a third memory to store an encryption key setting value; and
a processor to decrypt encrypted data which is stored in an external non-volatile memory using an encryption key corresponding to the encryption key setting value from among the plurality of encryption keys, to stores the decrypted data in the second memory, and performs boot using data stored in the second memory.

2. The system on chip as claimed in claim 1, wherein initialization data is stored in the first memory separately from the plurality of encryption keys,
wherein the processor performs initialization using the initialization data and decrypts the encrypted data.

3. The system on chip as claimed in claim 2, further comprising:
a first circuit to restrict access to the processor via an external port for a predetermined time.

4. The system on chip as claimed in claim 3, wherein, when power is switched on, the first circuit outputs a disable signal to disable the access to the processor, and, when at least the decryption and authentication of the decrypted data is completed, the first circuit outputs an enable signal to enable the access to the processor.

5. The system on chip as claimed in claim 4, wherein the first circuit comprises a first register,
wherein, when the decryption and authentication of the decrypted data is completed, the processor changes a storage value of the first register.

6. The system on chip as claimed in claim 5, further comprising:
a second circuit and a third circuit to control access to the first memory.

7. The system on chip as claimed in claim 6, wherein the second circuit comprises a second register, and the third circuit comprises a third register,
wherein, when the decryption and authentication of the decrypted data is completed, the processor stores a control value to disable access to the first memory in the second register, and stores a control value to change the access to the first memory to access to the second memory in the third register.

8. The system on chip as claimed in claim 1, wherein the processor executes an infinite loop when the decryption fails.

9. The system on chip as claimed in claim 1, wherein, when power is switched on, the processor identifies a memory that is designated by a setting value stored in the third memory or an external pin, and, when the first memory is designated, the processor performs secure boot using the encrypted data, and, when the second memory is designated, the processor performs normal boot using non-encrypted data which is stored in the non volatile memory.

10. The system on chip as claimed in claim 1, wherein the first memory is a mask Read Only Memory (ROM) or a one-time programmable (OTP) ROM,
wherein the second memory is a static random access memory (SRAM),
wherein the third memory is an electrical fuse (EFUSE) memory.

11. An image forming apparatus comprising:
a consumable unit in which a Custom Replaceable Unit Monitoring (CRUM) chip is mounted; and
a controller to perform an image forming job using the consumable unit and to update data recorded on the CRUM chip according to the image forming job,
wherein the controller comprises:
a non-volatile memory to record encrypted data; and
a system on chip to perform a secure boot using the encrypted data when the image forming apparatus is turned on, and control the image forming apparatus according to a user command when the secure boot is completed.

12. The image forming apparatus as claimed in claim 11, wherein the system on chip comprises:
a first memory to store a plurality of encryption keys;
a second memory;
a third memory to store an encryption key setting value is stored; and
a processor to decrypt data which is stored in the non-volatile memory using an encryption key corresponding to the encryption key setting value from among the plurality of encryption keys, to store the decrypted data in the second memory, and to perform boot using data stored in the second memory.

13. The image forming apparatus as claimed in claim 12, wherein initialization data is stored in the first memory separately from the plurality of encryption keys,
wherein the processor performs initialization using the initialization data and decrypts the encrypted data.

14. The image forming apparatus as claimed in claim 13, wherein, when a boot event has occurred, the system on chip restricts access to processor via an external port for a predetermined time.

15. The image forming apparatus as claimed in claim 14, wherein the system on chip further comprises:
a first circuit which, when the image forming apparatus is turned on, outputs a disable signal to disable the access to the processor, and, when at least the decryption and authentication of the decrypted data is completed, outputs an enable signal to enable the access to the processor.

16. The image forming apparatus as claimed in claim 15, wherein the first circuit comprises a first register,
wherein, when the decryption and authentication of the decrypted data is completed, the processor changes a storage value of the first register.

17. The image forming apparatus as claimed in claim 12, wherein, when at least the decryption and authentication of the decrypted data is completed, the processor performs a register setting job to disable access to the first memory and change the access to the first memory to access to the second memory.

18. The image forming apparatus as claimed in claim 12, wherein, when the image forming apparatus is turned on, the processor identifies a memory that is designated by a setting value stored in the third memory or an external pin, and when the first memory is designated, the processor performs secure boot using the encrypted data, and, when the second memory is designated, the CPU performs normal boot using non-encrypted data which is stored in the external non-volatile memory.

19. The image forming apparatus as claimed in claim 12, wherein the first memory is a mask Read Only Memory (ROM) or an one-time programmable (OTP) ROM,
wherein the second memory is a static random access memory (SRAM),
wherein the third memory is an electrical fuse (EFUSE) memory.

20. A method of booting of an image forming apparatus comprising a non-volatile memory and a system on chip, the method comprising:
initializing the image forming apparatus using initialization data which is stored in a first memory of the system on chip;
when the initializing is performed, decrypting encrypted data which is stored in the non-volatile memory using one of a plurality of encryption keys which are stored in the first memory;
storing the decrypted data in a second memory of the system on chip; and
performing a boot operation using data which is stored in the second memory.

21. The method as claimed in claim 20, further comprising:
when the image forming apparatus is turned on, identifying a memory that is designated according to an input value input through a third memory of the system on chip or an external pin; and
when the designated memory is the first memory, disabling access to a processor of the system on chip.

22. The method as claimed in claim 21, further comprising, when at least the decryption and authentication of the decrypted data is completed, enabling the access to the processor.

23. The method as claimed in claim 22, further comprising:
when the decryption and authentication of the decrypted data is completed, disabling the access to the first memory; and
performing register setting to change the access to the first memory to access to the second memory.

24. The method as claimed in claim 20, further comprising:
accessing the first memory with the processor according to a reset vector to retrieve an instruction, where the first memory is designated by the reset vector.
